(19) United States
(12) Patent Application Publication
(10) Pub. No.: US 2004/0076220 A1
(43) Pub. Date: Apr. 22, 2004

(54) Method for identifying the classification of temperature detection components of electronic thermometers

(76) Inventor: Daniel C.M. Tseng, Taipei Hsien (TW)

Correspondence Address: BIRCH STEWART KOLASCH & BIRCH, PO BOX 747, FALLS CHURCH, VA, 22040-0747, US

(21) Appl. No.: 10/274,262

(22) Filed: Oct. 21, 2002

(51) Int. Cl. G01K 7/00

(52) U.S. Cl. 374/185; 374/163; 374/183

(57) ABSTRACT

A method for identifying the classification of temperature detection components of the electronic thermometer that has a disposable temperature detection component and a main device for measuring and displaying temperature. To achieve measuring accuracy, the temperature detection component has a classification identification zone formed on a desired location. When the temperature detection component is coupled to the main device, the main device determines the classification attribute of a temperature detection element of the temperature detection component based on the indication of the classification identification zone, and through process software resided in the main device automatically calculates and displays the accurate temperature value.

### FIELD OF THE INVENTION

The present invention relates to a method for identifying the classification of temperature detection components, particularly for detachable electronic thermometers that have a classification identification zone on the temperature detection component. The main device of the electronic thermometer so that can identify the classification attribute of the temperature detection component automatically when the temperature detection component is coupled to the main device for measuring temperature, and outputs accurate temperature reading.

### BACKGROUND OF THE INVENTION

There are many types of electronic thermometers have been developed for clinical use, such as pen type thermometers made in rigid or flexible probe, nipple type thermometers, infrared ear thermometers and the like. They are generally being constructed in an integrated or a detachable manner (with the temperature detection component separated from the main device). Most electronic thermometers adopt the basic principle that different temperatures cause output variations of the resistance or voltage of thermo-sensitive resistors (thermistor) or other thermal inductive elements. The variations are transformed to a measured temperature reading for output.

However, the detection element in the electronic thermometer (usually thermistor or other thermal inductive elements) has certain tolerances in physical property, such as a small variation of resistance or voltage output value. Such tolerances could cause the measured temperature value not conforming to the accuracy range required by international product regulations (within ±0.1° C. or ±0.2° F.). In order to meet the accuracy range required by the international product regulations, manufacturer of electronic thermometer has to setup necessary processes to remedy or compensate the tolerance by means of pairing a resistor or software calibration according to the attributed classification of the elements. For conventional integrated electronic thermometers, the compensation of attribute classification through pairing resistor or software calibration can be achieved inside the same electronic thermometer without affecting the measuring accuracy. However, for detachable electronic thermometers, the measuring accuracy could be lost because of the replacement of the detection component, the electronic thermometer so that could become not usable because of non-accurate.

### SUMMARY OF THE INVENTION

Therefore the primary object of the invention is to resolve the aforesaid disadvantages occurred to detachable electronic thermometers to provide a low cost and disposable temperature detection component. In addition to maintain the required measuring accuracy, its low cost can be widely used in hospitals to overcome the mercury pollution problem occurred by mercury thermometers. The method of the invention is to add a classification identification zone on the temperature detection component that enables the main device to identify the classification of the temperature detection element of the temperature detection component, and to automatically process and output accurate temperature value.

The temperature detection component of the invention includes a thermo-sensitive resistor (usually a thermistor) and a classification identification zone. The classification identification zone is set according to the classification attribute of the thermo-sensitive resistor (usually a thermistor). When the temperature detection component is coupled to the main device, the main device determines the classification preset on the classification identification zone of the temperature detection component, then calculates the signals measured and output by the temperature detection component. Based on the classification attribute of the thermo-sensitive resistor (usually a thermistor), the device so provides an accurate temperature reading.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of first embodiment of the invention.

FIG. 2 is a schematic view of second embodiment of the invention.

FIGS. 3A-3C are schematic views of a classification identification zone of the invention, coding concept.

FIGS. 4A-4C are schematic views of a classification identification zone of the invention, formed by punched holes.

FIGS. 5A-5C are schematic views of a classification identification zone of the invention, formed by notches.

FIGS. 6A-6C are schematic views of a classification identification zone of the invention, formed by open/short circuits.

FIGS. 7A and 7B are schematic views of a classification identification zone of the invention, formed by a photosensitive (photo mask) array.

FIGS. 8A and 8B are schematic views of a classification identification zone of the invention, formed by an electric conductive (non-conductive) array.

### DESCRIPTION OF THE PREFERRED EMBODIMENTS

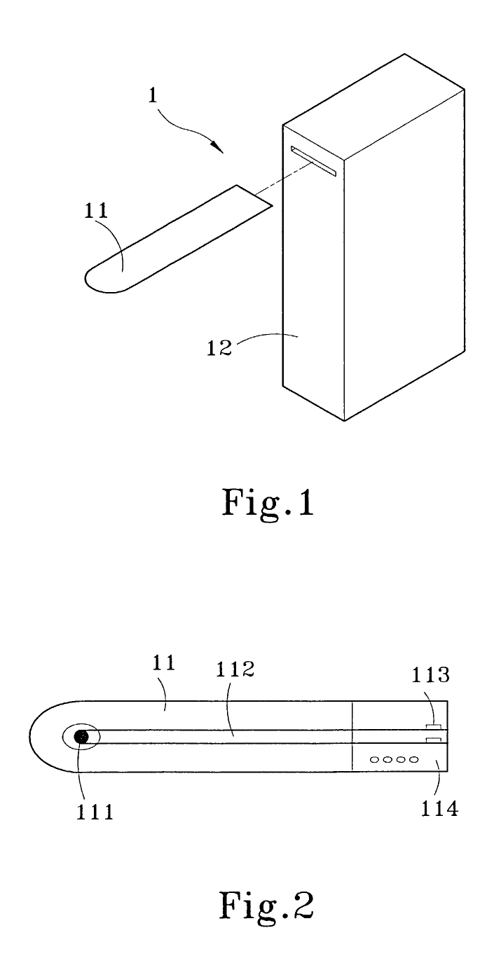

Refer to FIGS. 1 and 2 for the first and second embodiments of the invention. The method for identifying the classification of temperature detection components of the electronic thermometer is to set a classification identification zone 114 on a desired location of a temperature detection component 11 of a detachable electronic thermometer 1. After the temperature detection component 11 has completed the measurement, a main device 12 is coupled with temperature detection component 11 to read the measured signals. And based on the classification identification zone 114 of the temperature detection component 11, the main device 12 can distinguish the classification indication of a temperature detection element 111 located in the temperature detection component and recognize the classification attribute, and automatically processes and displays an accurate temperature reading.

The temperature detection component 11 set forth above is a thin plate including a temperature detection element 111, signal transmission wires 112 which have one end connected to the temperature detection element 111 and another end extended to a contact terminal 113 located at one end of the temperature detection component 11. After the temperature detection component 11 has completed temperature measurement and is coupled to the main device 12, the contact terminal 113 of the temperature detection component 11 contacts the main device 12. The measured value of the temperature detection element 111 is transmitted to the main device 12 through the contact terminal 113. The main device 12 starts to process and display signal value measured by the temperature detection component 11.

The temperature detection element 111 is usually formed by a thermistor. Since the thermistor has tolerance under the element specification, it may result in different thermal resistance characteristics. Thus if, without be classified, the thermistor is directly installed on the temperature detection component 11, or one person uses two sets of temperature detection component 11 to do the measurement, the measured temperatures will be different that is mainly caused by the tolerance of every thermistor. In medical practices, the regulation for tolerance of measuring temperature is within the range of ±0.1° C. or ±0.2° F. Hence the tolerance of the thermistor itself will make it difficult to control the tolerance of the measuring temperature within the range of ±0.1° C. or ±0.2° F.

Therefore the invention provides a method that manufacturer re-measures the thermistor and makes further classification according to the characteristics of every thermistor within the tolerance range. The attribute of the classification is preset in the classification identification zone 114 of the temperature detection component 11. When the temperature detection component 11 is coupled to the main device 12, the main device 12 firstly reads the classification identification zone 114 to determine the classification attribute of the temperature detection element 111, then based on the classification attribute to calculate the signal value measured by the temperature detection component 11 to provide an accurate temperature reading.

The method of presetting the classification attribute on the classification identification zone 114 mentioned above may be, but not limited to, punched holes, metal contacts (to form short circuits or circuit breaking), notches, photosensitive (photo masking) and electric conductive (non-conductive) approaches.

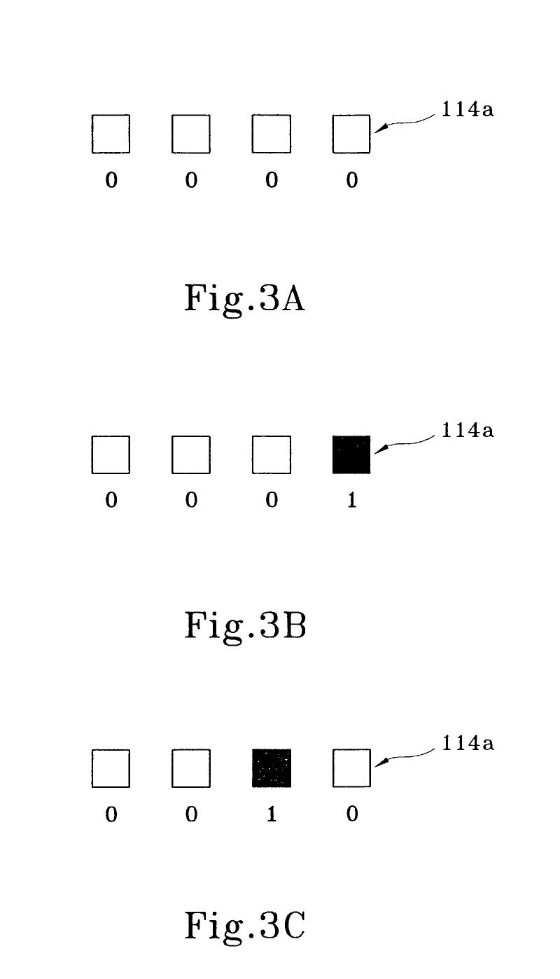

The FIGS. 3A-3C demonstrate coding concept of the classification identification of the invention. As shown in the drawings, the codes 114a are formed in the classification identification zone 114 of the temperature detection component 11 and may be binary, octarary, decimal, or sixteen scale codes. For instance, when using the binary code 114a, a 2×2×2×2=16 categories may be made. If the classification attribute of the measuring thermistor is category A (for the temperature detection element 111), the classification code is “0000”, as shown in FIG. 3A, and the four boxes in the classification identification zone 114a are blank. If the classification attribute is category B, the code is “0001”, as shown in FIG. 3B, then only the first box in the classification identification zone 114a is masked. In the event that the classification attribute is category C, the code is “0010”, as shown in FIG. 3C, the second box of the classification identification zone 114a is masked. The same principle may be applied to other classification attributes with different codes. Thus when the temperature detection component 11 is coupled to the main device 12, the main device 12 determines the classification attribute of the temperature detection element 111 based on the code 114a, then calculates the signal value measured by the temperature detection component 11 according to the classification attribute to provide an accurate temperature reading.

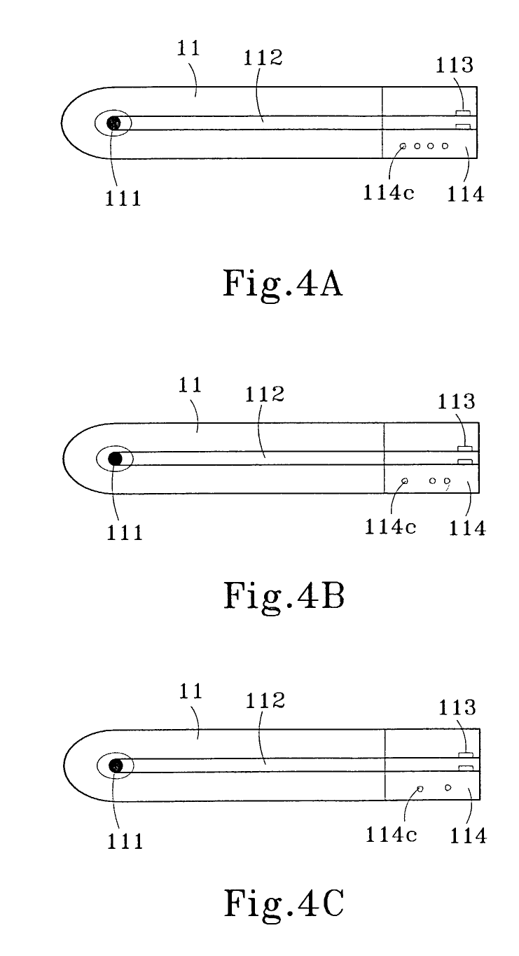

Referring to FIGS. 4A-4C for the classification identification zone of the invention formed by punched holes. As shown in the drawings, the classification of the temperature detection element 111 is indicated by an array of punched holes 114c. When the temperature detection component 11 is coupled to the main device 12, the main device 12 determines the classification attribute of the temperature detection element 111 based on punched holes 114c formed on the classification identification zone 114, then calculates the signal value measured by the temperature detection component 11 according to the classification attribute to provide an accurate temperature reading.

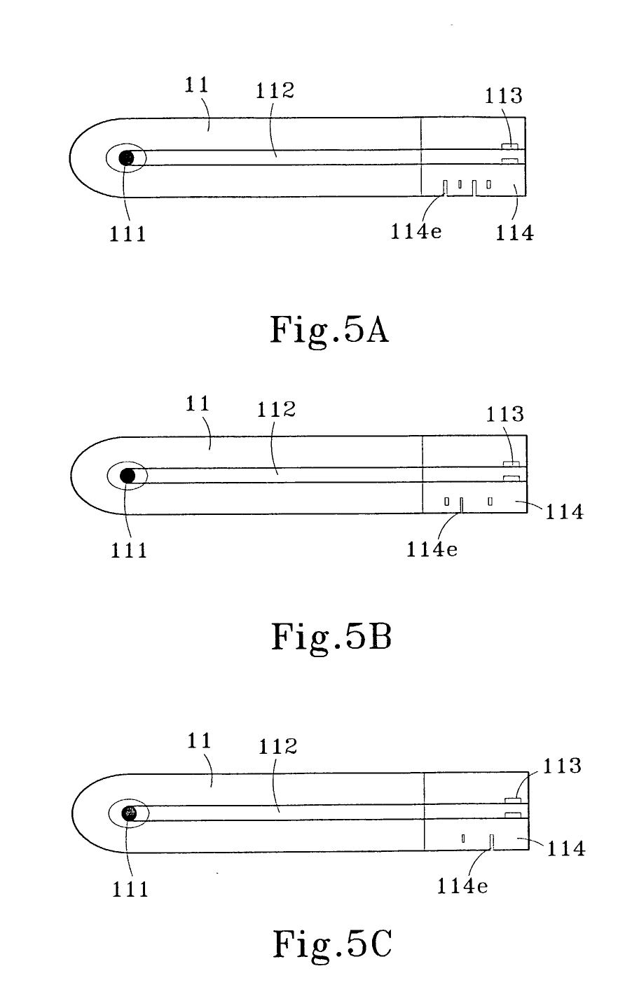

Referring to FIGS. 5A-5C for the classification identification zone of the invention formed by notches. As shown in the drawings, the classification of the temperature detection element 111 is indicated by an array of notches. I.e. the classified temperature detection element 111 has an array of notches 114e arranged in different fashions on the classification identification zone 114 of the temperature detection component 11. When the temperature detection component 11 is coupled to the main device 12, the main device 12 determines the classification attribute of the temperature detection element 111 based on the arrangement of the notches 114e, then calculates the signal value measured by the temperature detection component 11 according to the classification attribute to provide an accurate temperature reading.

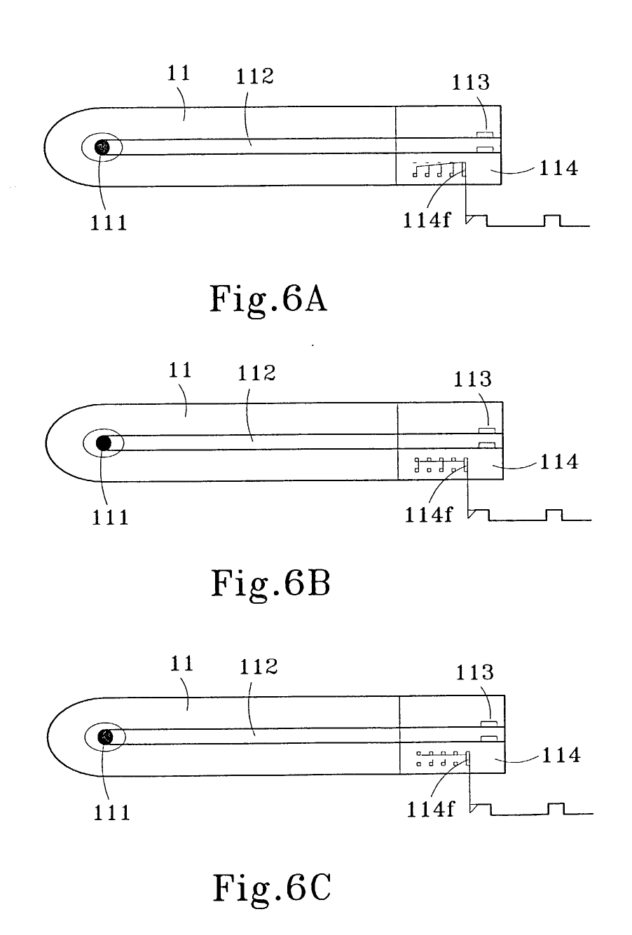

Referring to FIGS. 6A-6C for the classification identification zone of the invention formed by an open/short circuit. As shown in the drawings, the classification attribute of the temperature detection element 111 is determined by means of a printed circuit board. The classification identification zone 114 of the temperature detection component 11 is printed with a conductive material foil 114f to form an open/short circuit. When the temperature detection component 11 is coupled to the main device 12, the main device 12 determines the classification attribute of the temperature detection element 111 based on the connecting condition of the short or open circuit, then calculates the signal value measured by the temperature detection component 11 according to the classification attribute to provide an accurate temperature reading.

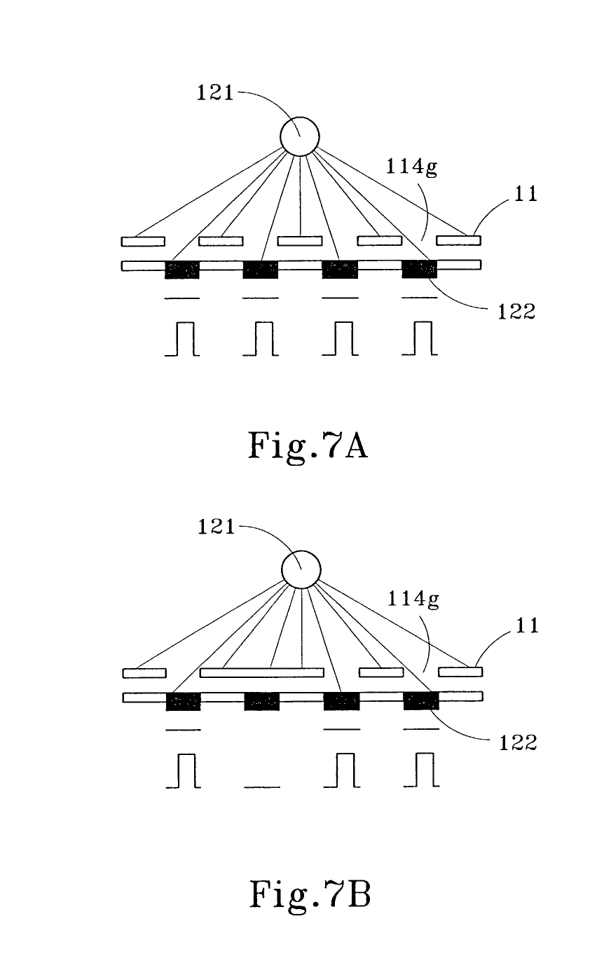

Referring to FIGS. 7A and 7C for the classification identification zone of the invention formed by a photosensitive (photo mask) methodology. As shown in the drawings, the classification attribute of the temperature detection element 111 is determined through a photosensitive (photo mask) indication means. There are apertures 114g (such as punched holes or notches) formed on the classification identification zone 114 of the temperature detection component 11. When the temperature detection component 11 is coupled to the main device 12, a light source 121 located in the main device 12 projects light through the apertures 114g. The light is received by photosensitive elements 122 located on another side of the main device 12. Those areas that do not have apertures block the light from passing to the corresponding photosensitive elements 122. The main device 12 determines the classification attribute of the temperature detection element 111 based on the photo sensing pattern, then calculates the signal value measured by the temperature detection component 11 according to the classification attribute to provide an accurate temperature reading.

On the other hand, the principle adopted above may be reversed. I.e. to use the pattern of the light source 121 that does not pass through the apertures 114g to determine the classification attribute of the temperature detection element 111.

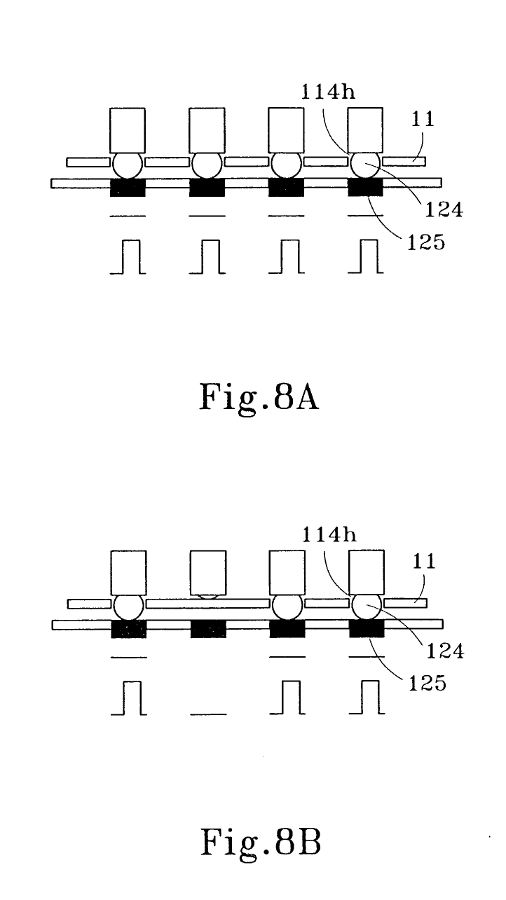

Referring to FIGS. 8A and 8C for the classification identification zone of the invention formed by an electric conductive(nonconductive) methodology. As shown in the drawings, the attribute of the temperature detection element 111 is determined through an electric conductive (non-conductive) means. There are apertures 114h (such as punched holes or notches) formed on the classification identification zone 114 of the temperature detection component 11. When the temperature detection component 11 is coupled to the main device 12, probes 124 located in the main device 12 pass through the apertures 114h to connect contact points 125 formed on another side of the main device 12 to establish electric conductive conditions. Those areas that do not have apertures prevent the probes 124 from passing through, thus do not establish electric conduction with the contact points 125. The main device 12 determines the classification attribute of the temperature detection element 111 based on the conduction pattern, and calculates the signal value measured by the temperature detection component 11 according to the classification attribute to provide an accurate temperature reading.

On the other hand, the principle adopted above may be reversed. I.e. to use the pattern of the probes 124 that are prevented from passing through the apertures 114h to determine the classification attribute of the temperature detection element 111.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method for identifying the classification of a temperature detection component of an electronic thermometer that has a disposable temperature detection component which includes a temperature detection element and a classification identification zone with a setting made according to classification attributes of the temperature detection element, and a main device for measuring and displaying a temperature output value, comprising the steps of:
coupling the temperature detection component to the main device;
determining the classification attributes of the temperature detection element according to the setting on the classification identification zone;
calculating signal values measured by the temperature detection component based on the classification attributes; and
outputting the temperature value.

2. The method of claim 1, wherein the temperature detection element is a thermo-sensitive resistor.

3. The method of claim 1 or 2, wherein the temperature detection element connects to a signal transmission wire which is extended to one end of the electronic thermometer to connect to a contact terminal.

4. The method of claim 1, wherein the coding system determining the classification attribute of the classification identification zone is selected from the group consisting of punching holes, metal contacts (to form short circuits or open circuits), notches, photosensitive (photo masking) and electric conducting (non-conducting).

5. The method of claim 4, wherein the coding system is selected from the group consisting of, but not limited to, binary system, octonary system, decimal system, or sixteen scale system.

6. The method of claim 4, wherein the classification identification zone is indicated by a punched hole array formed on the classification identification zone to allow the main device to identify the classification attributes of the temperature detection element after the temperature detection component has been coupled with the main device.

7. The method of claim 4, wherein the classification identification zone is done by means of a notch array with notches formed on the classification identification zone of the temperature detection component such that the main device is allowed to determine the classification attributes of the temperature detection element based on the arrangement of the notches after the temperature detection component has been coupled with the main device.

8. The method of claim 4, wherein the classification identification zone is done by means of a printed circuit board, the classification identification zone of the temperature detection component being printed with a conductive material foil to form a short circuit or a open circuit such that the main device is allowed to determine the classification attributes of the temperature detection element based on connection patterns of the short circuit or the open circuit after the temperature detection component has been coupled with the main device.

9. The method of claim 4, wherein classification indication of the classification identification zone is done through a photosensitive means, the classification identification zone of the temperature detection component having a plurality of apertures formed on selected locations thereof, the main device having a light source on one side thereof and photosensitive elements located on another side thereof such that when the temperature detection component is coupled to the main device the light source emitting light to pass through the apertures and reach the photosensitive elements, and to be blocked by the classification identification zone at where the apertures are not formed to allow the main device to determine the classification attribute of the temperature detection element.

10. The method of claim 4, wherein classification indication of the classification identification zone is determined through a photo mask means that employs a light source which is blocked from passing through apertures to form a pattern to determine the classification attribute of the temperature detection element.

11. The method of claim 4, wherein classification indication of the classification identification zone is determined by means of electric conductive conditions, the classification identification zone of the temperature detection component having a plurality of apertures formed on selected locations thereof, the main device having a plurality of probes on one side and a plurality of contact points located on another side thereof such that when the temperature detection component is coupled to the main device, the probes passing through the apertures to connect the contact points to establish electric conduction and the probes being blocked by the classification identification zone at where the apertures are absent to form a open circuit condition thereby to allow the main device to determine the classification attribute of the temperature detection element.

12. The method of claim 4, wherein classification indication of the classification identification zone is determined by means of electric non-conductive conditions that employs probes being prevented from passing through apertures to form a pattern to determine the classification attribute of the temperature detection element.
